(19) United States
(12) Patent Application Publication
(10) Pub. No.: US 2005/0168975 A1
(43) Pub. Date: Aug. 4, 2005

(54) Flashlight with multi-brightness levels

(76) Inventor: Joy Chen, Burlingame, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/861,422

(22) Filed: Jun. 7, 2004

(30) Foreign Application Priority Data
Feb. 4, 2004 (TW) 93201630

(51) Int. Cl. F21L 4/02

(52) U.S. Cl. 362/184

(57) ABSTRACT

A flashlight with multi-brightness levels comprising a body structure, which comprises a body and a head cover screwing onto each other. There is a hollow compartment, where batteries are placed in the body structure. The head cover screws onto the top of the body structure. There is a lighting device, which comprises multiple sets of light bulbs placed in the interior on the top of the body structure. There is also a forward contact device, which comprises at least one set of separatable upper and lower conductors placed in the interior of the body structure and under the lighting device. The forward contact device also comprises an axel, which joins into the conductor device. When screwing the body structure and the head cover, the movement activates the axel contacting the battery. Furthermore, the axel lifts the conductor device, so that the upper and lower conductors separate or contact each other. The spring device comprises multiple springs opposite to the light bulbs of the multiple lighting sets. The spring is electrically connected between the light bulb and the conductor device. By separating or connecting the upper and lower conductors of the conductor device, different brightness or color is chosen.

### BACKGROUND OF THE INVENTION

1. Field of the Invention

The present invention relates to a flashlight with multi-brightness levels. More specifically, the present invention discloses a flashlight with rotatable contact structure in order to adjust different brightness levels.

2. Description of the Prior Art

Conventional flashlights require only a light bulb. The brightness of the conventional flashlights is determined by the intensity of the light bulb. Then, flashlights with multiple light bulbs were invented. Today, LED's are widely used; flashlights with LED's have become standard. In order to develop a flashlight with multiple light bulb sets of different brightness's, a rotatable disk, which comprises a conductor structure, is applied on the existing flashlights. By turning the disk, the conducting points contact different circuits and a different set of lights is emitted. However, the disk is easily damaged when turning it, which causes malfunctions.

Due to the disadvantages and imperfections of the existing flashlight with multi-brightness levels, the present invention solves the mentioned problems, and provides a flashlight with multi-brightness levels; in order to have a better, more economical and convenient product.

### SUMMARY OF THE INVENTION

To achieve these and other advantages and in order to overcome the disadvantages of the conventional method in accordance with the purpose of the invention as embodied and broadly described herein, the present invention provides a flashlight with multi-brightness levels.

An objective of the present invention is to provide a flashlight with multi-brightness levels so that a different brightness level can be chosen as needed.

Another objective of the present inventions is to provide a flashlight with multi-brightness levels, so that different colors of lights can be chosen; in order to enhance the emission at nighttime or in special circumstances.

Another objective of the present invention is to provide a flashlight with multi-brightness levels, in order to enhance the usage stability of multi-brightness levels; as well as the quality.

In order to achieve the objectives mentioned above and other objectives, the present invention comprises a body structure, which comprises a main body and a head cover screwing onto each other. The body structure also comprises a hollow compartment, where batteries can be stored. The head cover is screwed onto the top of the body structure. There is a lighting device, which comprises multiple light bulb sets on the top interior of the head cover. There is a forward contact device, which comprises a conductor device, a forward device and a spring in the head cover under the lighting device. The conductor comprises at least one set of separatable upper and lower conductors. The forward device comprises at least one axel, which joins into the conductor device. When screwing the body structure and the head cover, the movement activates the axel contacting the battery. Furthermore, the axel lifts the conductor device, so that the upper and lower conductors separate or contact each other. The spring device comprises multiple springs opposite to the light bulbs of the multiple lighting sets. The spring is electrically connected between the light bulb and the conductor device. By separating or connecting the upper and lower conductors of the conductor device, different brightness or color is chosen.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

In the drawings,

FIG. 1 is a 3-dimentional diagram illustrating components of a flashlight with multi-brightness levels according to an embodiment of the present invention;

FIG. 2 is a partial blow-up cross section illustrating components of a flashlight with multi-brightness levels according to an embodiment of the present invention;

FIG. 3 is a cross section illustrating components of a flashlight with multi-brightness levels according to an embodiment of the present invention;

FIG. 4 is a partial blow-up diagram illustrating screwing operation of a flashlight with multi-brightness levels according to an embodiment of the present invention;

FIG. 5 is a diagram illustrating the screwing operation of emission of a flashlight with multi-brightness levels according to an embodiment of the present invention;

FIG. 6 is a partial blow-up diagram illustrating the continuous screwing operation of a flashlight with multi-brightness levels according to an embodiment of the present invention; and

FIG. 7 is a diagram of screwing operation of emission of a flashlight with multi-brightness levels according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

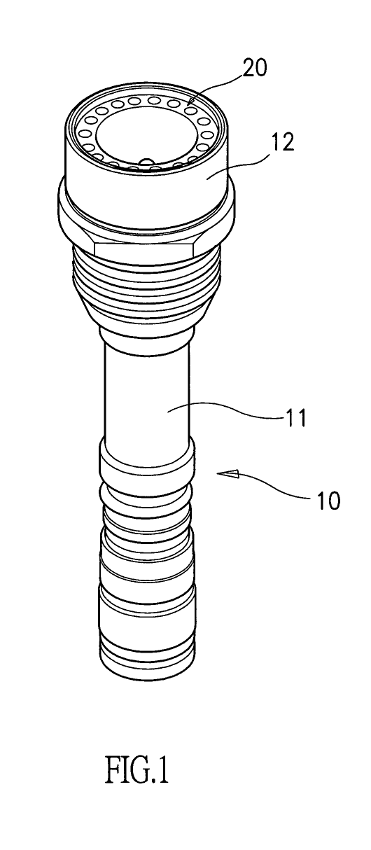

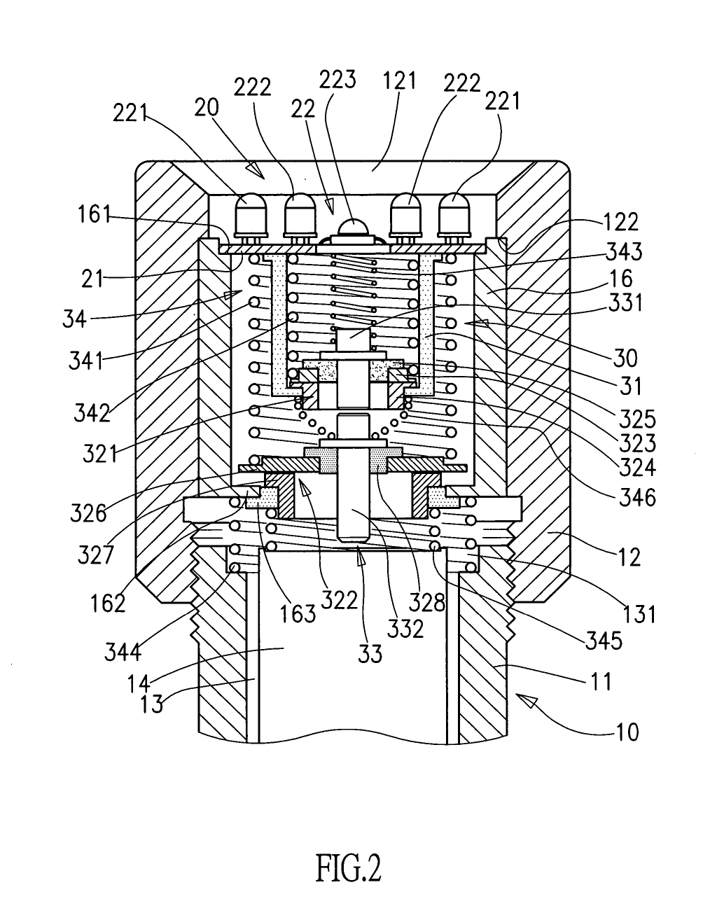

Please refer to FIGS. 1, 2, and 3. A flashlight with multi-brightness levels comprises a body structure 10, lighting device 20 and a forward contact device 30. The body structure 10 comprises a body 11 and a head cover 12 screwing onto each other. There is a hollow compartment 13, where batteries 14 can be placed in the body 11. There is a switch 15 on the end of the body 11. The switch 15 can be pressed to electrically connect to the batteries 14. There is also a stop socket 131, of which the diameter is slightly larger on the top of the hollow compartment 13 in the body 11. The head cover 12 is screwed onto the top of the body 11. There is a hole 121 and a stop end 122 on the top of the head cover 12. There is an inner casing 16 on the interior of the head cover 12. The top of the inner casing 16 touches the stop end 122 of the head cover 12. There is a positioning socket 161 on the top of the inner casing 16 and a stopper 162 on the bottom. There is an insulator ring 163 on the interior of the stopper 162.

The lighting device 20, which comprises a baseboard 21 and multiple LED lights 22 positioned on the top of the interior of the head cover 12. The baseboard 21 is placed in the positioning socket 161 in the inner casing 16. There is a circuit on the baseboard 21 (such as a circuit board). The multiple LED lights 22 are also on the baseboard 21. As shown in the figures, the multiple LED lights 22 are divided into the first LED set 221, the second LED set 222 and the third LED set 223. The terminals of the first, second and third LED sets are electrically connected to the opposite circuit of the baseboard 21.

The forward contact device 30 comprises a carrier 31, a conductor device 32, a forward device 33 and a spring device 34. The conductor device 32 comprises a first conductor set 321 and a second conductor set 322. The first conductor set 321 further comprises a first upper conductor 323 and a first lower conductor 324. The first upper conductor 323 can be placed separately on the top of the first lower conductor 324. There is an axel socket 325 on the top of the first upper conductor 323. The first upper conductor 323 is placed on the top of the carrier 31. The second conductor set 322 further comprises a second upper conductor 326 and a first lower conductor 327. The second upper conductor can be placed separately on the top of the second lower conductor 327. There is an axel socket 328 on the top of the second upper conductor 326. The second lower conductor 327 is placed on the ring 163 of the inner casing 16. The forward device 33 comprises the first axel 331 and the second axel 332 that are connectable and separatable. The first axel 331 is placed in the axel socket 325 of the first upper conductor 323 and can activate the first upper conductor 323. The second axel 332 is placed in the axel socket 328 of the second upper conductor 326, and can activate the second upper conductor 326. The spring device 34 comprises a first spring 341, a second spring 342 and the third spring 343. The first spring 341 is placed between the baseboard 21 and the second upper conductor 326. The first spring 341 is also electrically connected to the opposite circuit of the first LED set 221. The second spring 324 is placed between the baseboard 21 and the first upper conductor 323. The second spring 341 is also electrically connected to the opposite circuit of the second LED set 222. The third spring 343 is placed between the baseboard 21 and the first axel 331. The third spring 343 is also electrically connected to the opposite circuit of the third LED set 223. The spring device 34 further comprises a conducting spring 344, a first stop spring 345 and a second stop spring 346. The conducting spring 344 is placed between the inner casing 16 and the stop socket 131 of the body 11. The first stop spring 345 is placed between the batteries 14, insulating ring 163 of the inner casing 16 and the second lower conductor 327. And then, the second stop spring 346 is placed between the second axel 332, the carrier 31 and the first lower conductor 324.

According to the opposite circuit of the baseboard 21, the positive terminals of the first, second and third LED sets 221, 222, 223 are electrically connected to the inner casing 16, the conductor spring 344, the body 11, and then connected to the positive terminal of the batteries 14 through the switch 15.

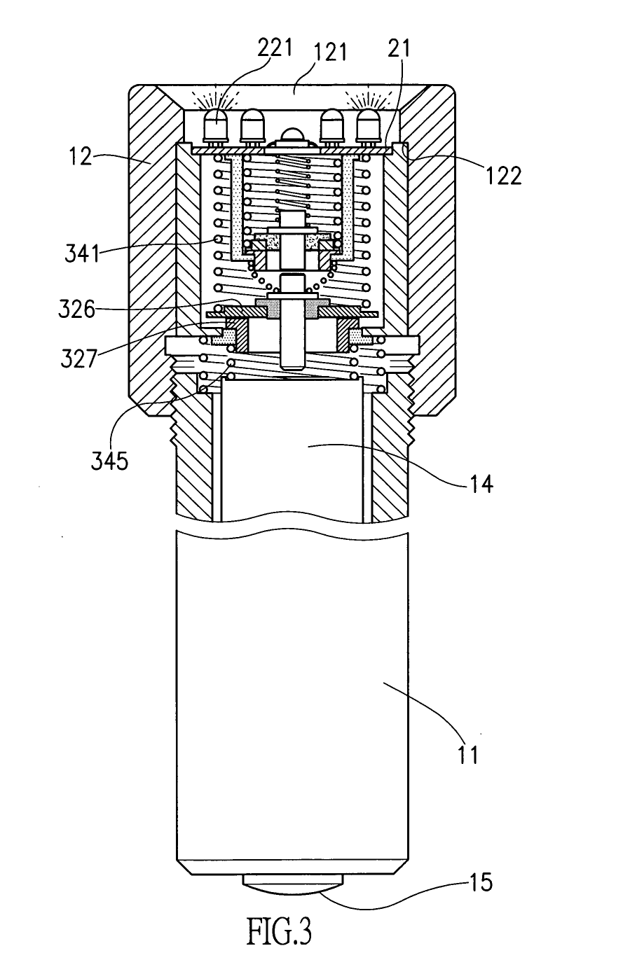

As shown in FIG. 3, according to the opposite circuit of the baseboard 21, the negative terminals of the first LED set 221 are electrically connected to the first spring 341, the second upper conductor 326, the second lower conductor 327, the first spring 345 and the negative terminal of the batteries 14. When the switch 15 is pressed or activated, the first LED set 221 will be lit.

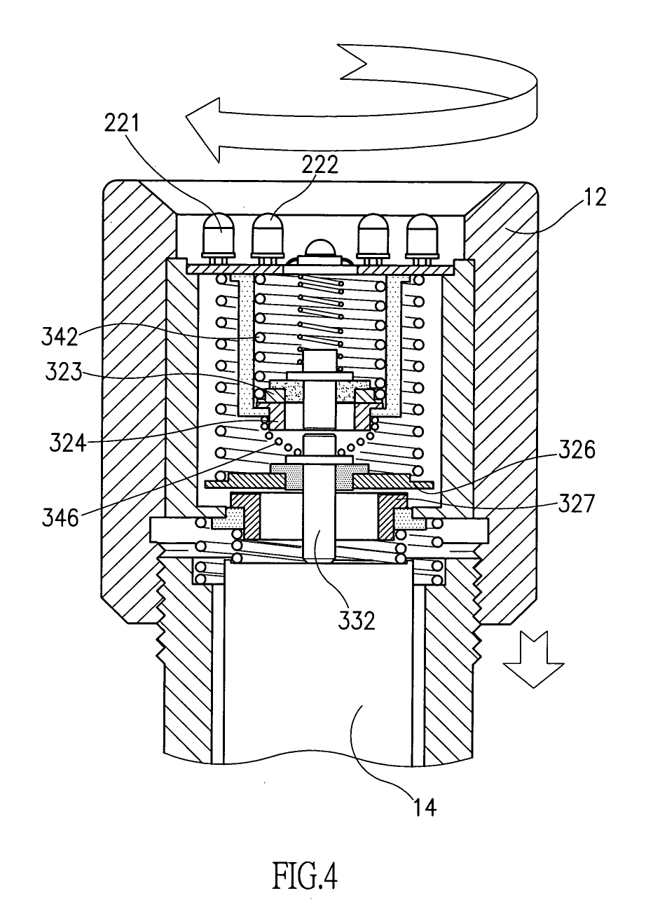

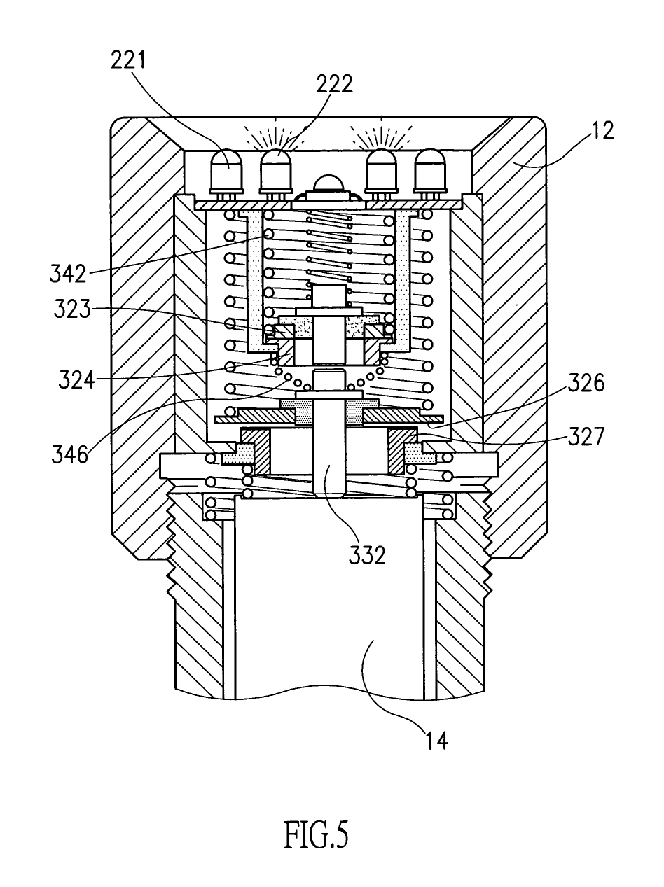

Please refer to FIGS. 4 and 5. When screwing or turning the head cover 12, the negative terminal of the batteries 14 is connected to the second axel 332. In the meantime, it also separates the second upper conductor 326 from the second lower conductor 327, due to moving of the second axel 332. Now the circuit of the first LED set 221 is off, so the light is off. However, according to the opposite circuit of the baseboard 21, the negative terminals of the second LED set 222 is electrically connected to the second spring 342, the first upper conductor 323, the second spring 346, the second axel 332 and the negative terminal of the batteries 14. Therefore, when the switch 15 is pressed, the second LED set 222 is lit.

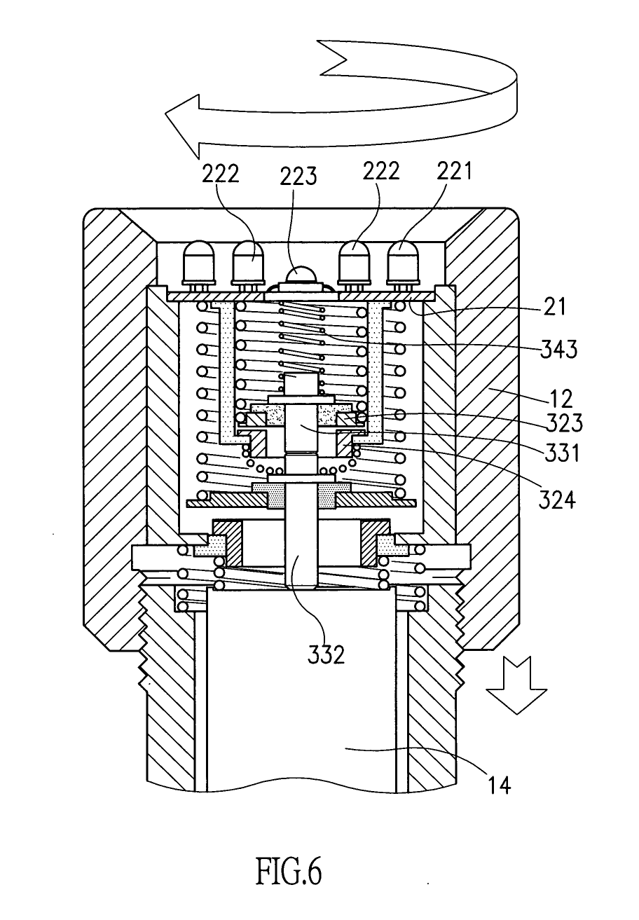

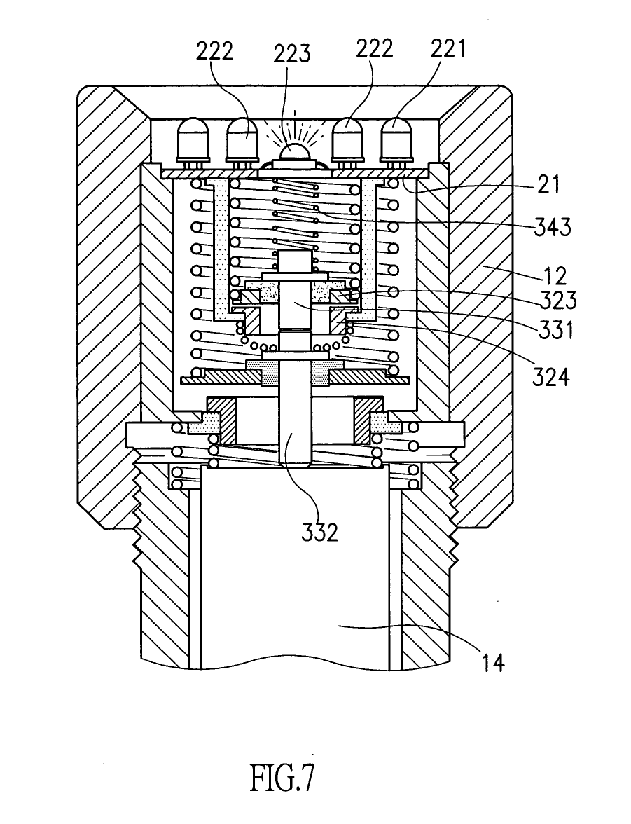

Please refer to FIGS. 6 and 7. When screwing the head cover 12 again, the negative terminal of the batteries 14 is further connected to the first axel 331. In the meantime, it also separates the first upper conductor 323 from the first lower conductor 324, due to moving the first axel 331. Now, the circuit of the second LED set is off. However, according to the opposite circuit of the baseboard 21, the negative terminals of the third LED set 223 is electrically connected to the third spring 343, the first axel 331, the second axel 332 and the negative terminal of the batteries 14. Therefore, when pressing the switch 15, the third LED set 223 is lit.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A flashlight with multi-brightness levels comprising:
a body structure;
a body and a head cover on the body structure screwing onto each other;
a hollow compartment, where batteries are stored;
a head cover screwed onto the top of the body;
a lighting device placed on the top of the interior of the head cover, where multiple light sets are stored;
a forward contact device, which comprises a conductor device, a forward device and a spring device placed in the head cover under the lighting device;
the conductor device comprising at least one set of separatable upper and lower conductors;
the forward device, which joins into the conductor device, comprising at least one axel; the screwing movement of the body and the head cover activate the batteries and the axel connected together; and then activate the separation and connection of the upper and lower conductor; and
the spring device comprising multiple springs opposite to multiple light bulbs; whereby separation and connection of the upper and lower conductor of the conductor device, different set of light is lit.

2. The flashlight with multi-brightness levels of claim 1, further comprising:
a stop socket, where there is a spring, in the hollow compartment on the top of the body.

3. The flashlight with multi-brightness levels of claim 2, further comprising:
an inner casing connecting to the conductor spring in the interior of the head cover.

4. The flashlight with multi-brightness levels of claim 3, further comprising:
a stop end connecting to the inner casing in the interior of the head cover.

5. The flashlight with multi-brightness levels of claim 3, further comprising:
an insulator ring in the interior of the inner casing, and a spring between the insulator ring and the batteries.

6. The flashlight with multi-brightness levels of claim 3, the lighting device further comprising:
a baseboard for installing the multiple light sets; the baseboard, which is placed in the inner casing, is electrically connected to the circuit of the light bulb.

7. The flashlight with multi-brightness levels of claim 1, the forward contact device further comprising:
an insulated carrier under the base board.

8. The flashlight with multi-brightness levels of claim 1, the conductor device further comprising:
a first conductor set, which comprises a first upper conductor and a first lower conductor; the first upper conductor, which is placed on the carrier, can be separately placed on the top of the first lower conductor.

9. The flashlight with multi-brightness levels of claim 1, the conductor device further comprising:
a second conductor set, which comprises a second upper conductor and a second lower conductor; the second upper conductor, which is placed in the carrier, can be separately placed on the ring of the inner casing.

10. The flashlight with multi-brightness levels of claim 1, the forward contact device further comprising:
a first axel and a second axel that can be separated and connected; the first axel, which is placed in the axel socket of the first upper conductor, can activate the movement of the first upper conductor.

11. The flashlight with multi-brightness levels of claim 10, further comprising:
a second axel, which is placed in the axel socket of the second upper conductor, for activating the movement of the second conductor.

12. The flashlight with multi-brightness levels of claim 10, the spring device further comprising:
a first spring, a second spring and a third spring.

13. The flashlight with multi-brightness levels of claim 11, the spring device further comprising:
a first spring, which is electrically placed and connected between the lighting device and the second upper conductor.

14. The flashlight with multi-brightness levels of claim 11, the spring device further comprising:
a second spring, which is electrically placed and connected between the lighting device and the first upper conductor.

15. The flashlight with multi-brightness levels of claim 11, the spring device further comprising:
a third spring, which is electrically placed and connected between the lighting device and the first axel.

16. The flashlight with multi-brightness levels of claim 11, the spring device further comprising:
a second stop spring placed between the second axel and the carrier and the first lower conductor.

17. The flashlight with multi-brightness levels of claim 9, further comprising:
a second lower conductor electrically connected to the stop spring.
